(19) United States
(12) Patent Application Publication
(10) Pub. No.: US 2007/0075955 A1
(43) Pub. Date: Apr. 5, 2007

(54) ORGANIC LIGHT EMITTING DIODE DISPLAY

(75) Inventors: Kwang-Chul JUNG, Seongnam-si (KR); Nam-Deog KIM, Yongin-si (KR); Beohm-Rock CHOI, Seoul (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 11/537,937

(22) Filed: Oct. 2, 2006

(30) Foreign Application Priority Data
Oct. 4, 2005 (KR) 10-2005-0092940

(51) Int. Cl. G09G 3/36

(52) U.S. Cl. 345/92

(57) ABSTRACT

The present invention relates to an OLED display including a first pixel, a second pixel, and a third pixel. Each pixel is defined by a gate line and a data line and includes a light-emitting element and a driving transistor connected to the light-emitting element. A light-emitting element of the first pixel has lower light emission efficiency than the light-emitting element of the second pixel and the third pixel, the light-emitting elements for the three pixels have substantially the same size, and an area occupied by the driving transistor of the first pixel is larger than an area occupied by the driving transistor of the second pixel and the third pixel.

### CROSS-REFERENCE TO RELATED APPLICATION

This application claims priority from and the benefit of Korean Patent Application No. 10-2005-0092940, filed on Oct. 04, 2005, which is hereby incorporated by reference for all purposes as if fully set forth herein.

### BACKGROUND OF THE INVENTION

1. Field of the Invention

The present invention relates to an organic light emitting diode display.

2. Discussion of the Background

Recent trends toward lightweight and thin personal computers and televisions require lightweight and thin display devices. Flat panel displays that satisfy this requirement are replacing conventional cathode ray tubes (CRTs).

Such flat panel displays include a liquid crystal display (LCD), a field emission display (FED), an organic light emitting diode (OLED) display, a plasma display panel (PDP), and so on.

Among flat panel displays, the OLED display may be the most promising because of its low power consumption, fast response time, wide viewing angle, and high contrast ratio.

The OLED display is a self-emissive device that includes an organic light emitting layer interposed between two electrodes. Holes from one electrode, and electrons from the other, are injected into the light emitting layer. The injected electrons and holes combine to form exitons, which emit light as they discharge energy.

An OLED display's emission efficiency varies depending on organic materials used to emit, for example, red, green, or blue light. To emit a given intensity of light, an OLED having lower emission efficiency requires more current. However, designing a pixel to provide more current to an OLED having lower emission efficiency may decrease the display device's aspect ratio, which negatively affects the display's overall quality and may decrease its commercial value.

The above information disclosed in this Background section is only for enhancement of understanding of the background of the invention and therefore it may contain information that does not form the prior art that is already known in this country to a person of ordinary skill in the art.

### SUMMARY OF THE INVENTION

This invention provides an OLED display with different pixel circuit structures among different colored pixels.

Additional features of the invention will be set forth in the description which follows, and in part will be apparent from the description, or may be learned by practice of the invention.

The present invention discloses an OLED display including a first pixel, a second pixel, and a third pixel. Each pixel is defined by a gate line and a data line, and each pixel includes a light-emitting element and a driving transistor connected to the light-emitting element. The light-emitting element of the first pixel has lower light emission efficiency than the light-emitting elements of the second pixel and the third pixel. The size of the light-emitting element for each of the first pixel, the second pixel, and the third pixel is substantially the same, and an area occupied by the driving transistor of the first pixel is larger than an area occupied by the driving transistor of the second pixel and the third pixel.

The present invention also discloses an OLED display including a first pixel, a second pixel, and a third pixel. Each pixel includes a light-emitting element and a driving transistor connected to the light-emitting element. The first pixel has a first light-emission region, the second pixel has a second light-emission region, and the third pixel has a third light-emission region. A light-emitting element of the first pixel has lower light emission efficiency than that of the light-emitting elements of the second pixel and the third pixel, the width and length of the first light-emission region are different from those of the second and third light-emission regions, and sizes of the first, second, and third light-emission regions are substantially the same.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is an equivalent circuit diagram of an OLED display according to an exemplary embodiment of the present invention.

FIG. 2, FIG. 3, and FIG. 4 are layout views respectively showing three different pixels of an OLED according to an exemplary embodiment of the present invention.

FIG. 5 is a sectional view taken along line V-V of FIG. 4.

FIG. 6 is a layout view showing an arrangement of the pixels of FIG. 2, FIG. 3, and FIG.4.

FIG. 7 is an equivalent circuit diagram of an OLED display according to another exemplary embodiment of the present invention.

FIG. 8, FIG. 9, and FIG. 10 are layout views respectively showing three different pixels of an OLED according to another exemplary embodiment of the present invention.

FIG. 11 is a sectional view taken along line XI-XI of FIG. 10.

FIG. 12 is a layout view showing an arrangement of the pixels of FIG. 8, FIG. 9, and FIG. 10.

### DETAILED DESCRIPTION OF THE ILLUSTRATED EMBODIMENTS

The present invention will now be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art.

In the drawings, the thickness of layers, films, panels, regions, etc., are exaggerated for clarity. Like reference numerals designate like elements throughout the specification. It will be understood that when an element such as a layer, film, region, or substrate is referred to as being “on” or “connected to” another element, it can be directly on or directly connected to the other element or intervening elements may also be present. In contrast, when an element is referred to as being “directly on” or “directly connected to” another element, there are no intervening elements present.

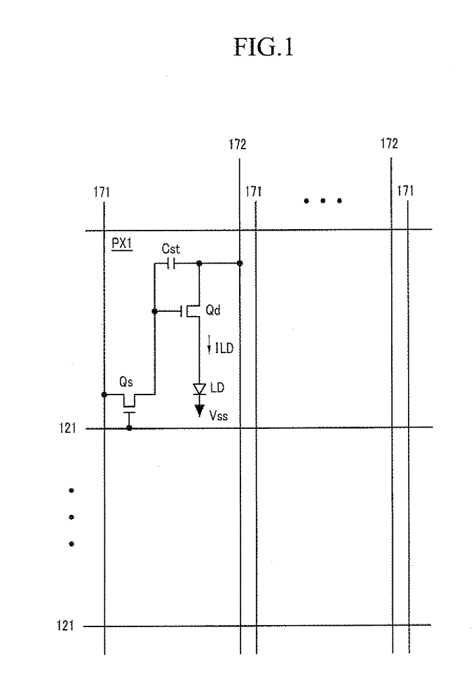

First, an OLED display according to an exemplary embodiment of the present invention is described in detail below with reference to FIG. 1, which is an equivalent circuit diagram of an OLED display.

Referring to FIG. 1, an OLED display according to an exemplary embodiment of the present invention includes a plurality of signal lines 121, 171, and 172, and a plurality of pixels PX1 connected thereto. The pixels PX1 are arranged substantially in a matrix.

The signal lines include a plurality of gate lines 121, which transmit gate signals (or scanning signals), a plurality of data lines 171, which transmit data signals, and a plurality of driving voltage lines 172, which transmit a driving voltage. The gate lines 121 extend substantially in a row direction and are substantially parallel to each other, while the data lines 171 and the driving voltage lines 172 extend substantially in a column direction and are substantially parallel to each other.

Each pixel PX1 includes a switching transistor Qs, a driving transistor Qd, a storage capacitor Cst, and an OLED LD.

The switching transistor Qs has a control terminal connected to one gate line 121, an input terminal connected to one data line 171, and an output terminal connected to a control terminal of the driving transistor Qd. The switching transistor Qs transmits a data signal from the data line 171 to the driving transistor Qd in response to the gate signal from the gate line 121.

The control terminal of the driving transistor Qd is connected to the switching transistor Qs, its input terminal is connected to one driving voltage line 172, and its output terminal is connected to the OLED LD. The driving transistor Qd drives an output current I_{LD}having a magnitude depending on the voltage between the control terminal and the output terminal thereof.

The capacitor Cst is connected between the control terminal and the input terminal of the driving transistor Qd. The capacitor Cst stores the data signal applied to the control terminal of the driving transistor Qd and maintains the data signal after the switching transistor Qs turns off.

An anode of the OLED LD is connected to the output terminal of the driving transistor Qd, and its cathode is connected to a common voltage Vss. The OLED LD emits light having an intensity depending on an output current I_{LD} of the driving transistor Qd, thereby displaying images.

The switching transistor Qs and the driving transistor Qd are shown in FIG. 1 as n-channel field effect transistors (FETs). However, at least one of the switching transistor Qs and the driving transistor Qd may be a p-channel FET. Additionally, the connections among the transistors Qs and Qd, the capacitor Cst, and the OLED LD may be modified.

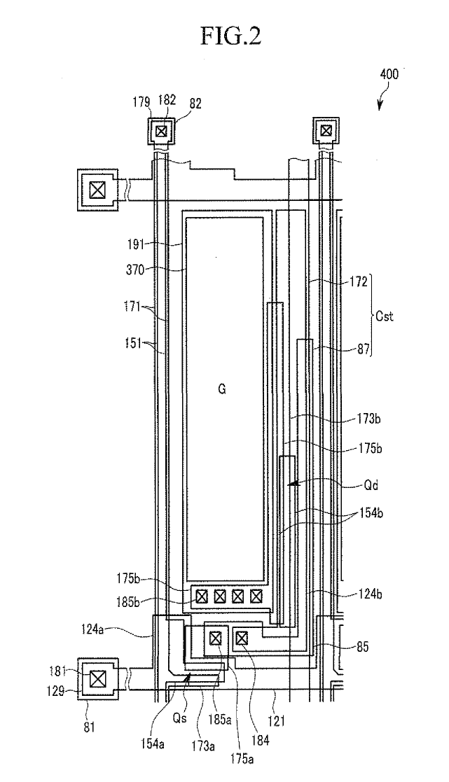

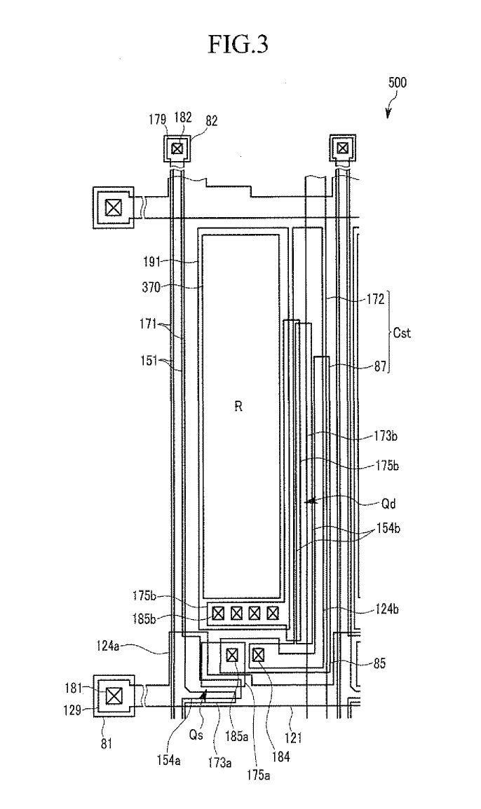

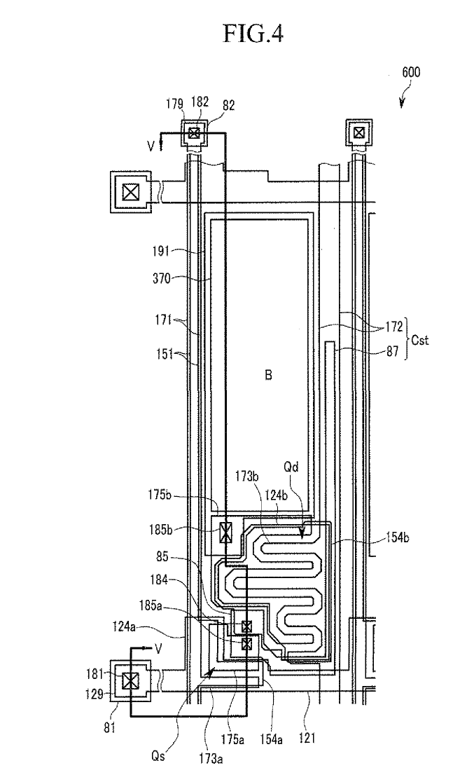

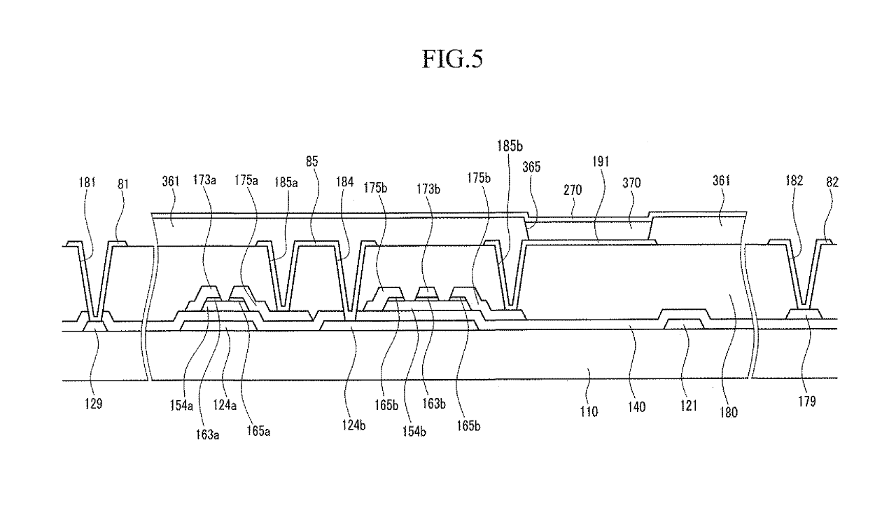

A detailed structure of the OLED display of FIG. 1 according to an exemplary embodiment of the present invention will be described in detail below with reference to FIG. 2, FIG. 3, FIG. 4, and FIG. 5.

FIG. 2, FIG. 3, and FIG. 4 are layout views respectively showing three different pixels of an OLED according to an exemplary embodiment of the present invention, and FIG. 5 is a sectional view taken along line V-V of FIG. 4. In FIG. 2, FIG. 3, FIG. 4, and FIG. 5, like elements are represented by like reference numerals.

A plurality of gate conductors, which include gate lines 121, including first control electrodes 124a, and second control electrodes 124b, are formed on an insulating substrate 110, which may be made of a material such as glass or plastic. The insulating substrate 110 may be transparent.

The gate lines 121 transmit gate signals and extend substantially in a transverse direction. Each gate line 121 further includes an end portion 129, which has a large area, to connect to another layer or an external driving circuit, and the first control electrodes 124aproject upward from the gate line 121. The gate lines 121 may extend to be directly connected to a gate driving circuit (not shown) that generates gate signals. The gate driving circuit may be integrated on the substrate 110.

The second control electrodes 124b are spaced apart from the gate lines 121.

The gate conductors 121 and 124b may be made of a metal such as Al, an Al alloy, Ag, an Ag alloy, Cu, a Cu alloy, Mo, an Mo alloy, Cr, Ta, Ti, etc. The gate conductors 121 and 124b may have a multi-layered structure including two conductive films that have different physical characteristics. In this case, one film may be made of a low resistivity metal such as Al, an Al alloy, Ag, an Ag alloy, Cu, or a Cu alloy in order to reduce signal delay or voltage drop. The other film may be made of a material such as Mo, an Mo alloy, Cr, Ta, or Ti, which has good physical, chemical, and electrical contact characteristics with other materials such as indium tin oxide (ITO) and indium zinc oxide (IZO). Examples of the combination of the two films include a lower Cr film and an upper Al (alloy) film, and a lower Al (alloy) film and an upper Mo (alloy) film. However, the gate conductors 121 and 124b may be made of various metals or conductors.

The lateral sides of the gate conductors 121 and 124b may be inclined at an angle of about 30 to about 80 degrees relative to a surface of the substrate 110.

A gate insulating layer 140, which may be made of silicon nitride (SiNx) or silicon oxide (SiOx), is formed on the gate conductors 121 and 124b.

A plurality of semiconductor stripes 151 and a plurality of semiconductor islands 154b, which may be made of hydrogenated amorphous silicon (“a-Si”) or polysilicon, are formed on the gate insulating layer 140. Each semiconductor stripe 151 extends substantially in a longitudinal direction and includes a plurality of projections 154a, which protrude toward the first control electrodes 124a. The semiconductor islands 154b are disposed on the second control electrodes 124b.

A plurality of pairs of first ohmic contacts 163a and 165a are formed on the semiconductor stripes 151, and a plurality of pairs of second ohmic contacts 163b and 165b are formed on the semiconductor islands 154b. The ohmic contacts 163a are stripe-shaped, while the ohmic contacts 163b, 165a, and 165b are island-shaped, and the ohmic contacts 163a, 163b, 165a and 165b may be made of silicide or n+ hydrogenated a-Si heavily doped with an n-type impurity such as phosphorous.

A plurality of data conductors including data lines 171, driving voltage lines 172, and first and second output electrodes 175a and 175b are formed on the ohmic contacts 163a, 163b, 165a, and 165b and the gate insulating layer 140.

The data lines 171 transmit data signals and extend substantially in the longitudinal direction to cross with the gate lines 121. Each data line 171 includes a plurality of first input electrodes 173a, which extend toward the first control electrodes 124a, and an end portion 179, which has a large area to connect to another layer or an external driving circuit. The data lines 171 may extend to be directly connected to a data driving circuit (not shown) that generates data signals. The data driving circuit may be integrated on the substrate 110.

The driving voltage lines 172, which transmit driving voltages, extend substantially in the longitudinal direction and cross the gate lines 121. Each driving voltage line 172 includes a plurality of second input electrodes 173b extending toward the second control electrodes 124b.

The first and second output electrodes 175a and 175b are spaced apart from each other, the data lines 171, and the driving voltage lines 172. Each pair of the first input electrodes 173a and the first output electrodes 175a are disposed opposing each other with respect to a first control electrode 124a, and each pair of the second input electrodes 173b and the second output electrodes 175b are disposed opposing each other with respect to a second control electrode 124b.

The data conductors 171, 172, 175a, and 175b may be made of a refractory metal such as Mo, Cr, Ta, Ti, or alloys thereof. They may have a multi-layered structure including a refractory metal film and a low resistivity film. Examples of the multi-layered structure include a double-layered structure including a lower Cr film and an upper Al (alloy) film, a double-layered structure of a lower Mo (alloy) film and an upper Al (alloy) film, and a triple-layered structure of a lower Mo (alloy) film, an intermediate Al (alloy) film, and an upper Mo (alloy) film. However, the data conductors 171, 172, 175a, and 175b may be made of other various metals or conductors.

Like the gate conductors 121 and 124b, the lateral sides of the data conductors 171, 172, 175a, and 175b may be inclined at an angle of about 30 to about 80 degrees relative to a surface of the substrate 110.

The ohmic contacts 163a, 163b, 165a, and 165b are interposed between the underlying semiconductor stripes and islands 151 and 154b and the overlying data conductors 171, 172, 175a, and 175b only, and they reduce the contact resistance therebetween. The semiconductor stripes and islands 151 and 154b include a plurality of exposed portions, which are not covered with the data conductors 171, 172, 175a, and 175b, such as portions disposed between the input electrodes and the output electrodes 173a,175a and 173b,175b.

A passivation layer 180 is formed on the data conductors 171, 172, 175a, and 175b and the exposed portions of the semiconductor stripes and islands 151 and 154b. The passivation layer 180 may be made of an inorganic insulator or an organic insulator, and it may have a flat top surface. Examples of the inorganic insulator include silicon nitride and silicon oxide. The organic insulator may have photosensitivity and a dielectric constant of less than about 4.0. The passivation layer 180 may include a lower film of an inorganic insulator and an upper film of an organic insulator, thereby utilizing the organic insulator's excellent insulating characteristics while preventing the exposed portions of the semiconductor stripes and islands 151 and 154b from being damaged by the organic insulator.

The passivation layer 180 has a plurality of contact holes 182, 185a, and 185b, which expose the end portions 179 of the data lines 171, the first output electrodes 175a, and the second output electrodes 175b, respectively, and the passivation layer 180 and the gate insulating layer 140 have a plurality of contact holes 181 and 184, which expose the end portions 129 of the gate lines 121 and the second control electrodes 124b, respectively.

A plurality of pixel electrodes 191, a plurality of connecting members 85, and a plurality of contact assistants 81 and 82 are formed on the passivation layer 180, all of which may be made of a transparent conductor such as ITO or IZO, or a reflective conductor such as Al, Ag, or alloys thereof.

The pixel electrodes 191 are connected to the second output electrodes 175bthrough the contact holes 185b.

The connecting members 85 are connected to the second control electrodes 124band the first output electrodes 175a through the contact holes 184 and 185a, respectively. Each connecting member 85 includes a storage electrode 87 extending along, and overlapping, a driving voltage line 172.

The contact assistants 81 and 82 are connected to the end portions 129 of the gate lines 121 and the end portions 179 of the data lines 171 through the contact holes 181 and 182, respectively. The contact assistants 81 and 82 may protect the end portions 129 and 179 and may enhance the adhesion between the end portions 129 and 179 and external devices.

A partition 361 is formed on the passivation layer 180. The partition 361 surrounds the pixel electrodes 191 like a bank to define openings 365, and it may be made of an organic insulator or an inorganic insulator. Further, the partition 361 may be made of a photosensitive material containing a black pigment so that the black partition 361 may serve as a light blocking member and its formation may be simplified.

A plurality of light emitting members 370 are formed on the pixel electrodes 191 and in the openings 365 defined by the partition 361. The light emitting members 370 may be confined in the openings 365. Each light emitting member 370 may be made of an organic material that emits red, green, or blue light. The OLED display displays images by spatially adding the monochromatic primary color lights emitted from the light emitting members 370.

Hereinafter, the pixels representing red, green, and blue light are referred to as red (R), green (G), and blue (B) pixels. FIG. 2 shows a G pixel 400, FIG. 3 shows a R pixel 500, and FIG. 4 shows a B pixel 600.

Each light emitting member 370 may have a multilayered structure including an emitting layer (not shown), which emits light, and auxiliary layers (not shown), which improve the emitting layer's light emission efficiency. The auxiliary layers may include an electron transport layer and a hole transport layer, which improve the balance of electrons and holes, and an electron injecting layer and a hole injecting layer, which improve the injection of electrons and holes.

A common electrode 270 is formed on the light emitting members 370 and the partition 361. The common electrode 270 is supplied with the common voltage Vss, and it may be made of a reflective metal such as Ca, Ba, Mg, Al, Ag, etc., or a transparent material such as ITO and IZO.

In the above-described OLED display, a first control electrode 124a connected to a gate line 121, a first input electrode 173a connected to a data line 171, and a first output electrode 175a, along with a projection 154a of a semiconductor stripe 151, form a switching TFT Qs. The channel of the switching TFT Qs is formed in the portion of the projection 154adisposed between the first input electrode 173a and the first output electrode 175a. Likewise, a second control electrode 124b connected to the first output electrode 175a, a second input electrode 173b connected to a driving voltage line 172, and a second output electrode 175bconnected to a pixel electrode 191, along with a semiconductor island 154b, form a driving TFT Qd. The channel of the driving TFT Qd is formed in the portion of the semiconductor island 154b disposed between the second input electrode 173b and the second output electrode 175b.

A pixel electrode 191, a light emitting member 370, and the common electrode 270 form an OLED LD having the pixel electrode 191 as an anode and the common electrode 270 as a cathode, or vice versa. The overlapping portions of a storage electrode 87 and a driving voltage line 172 form a storage capacitor Cst.

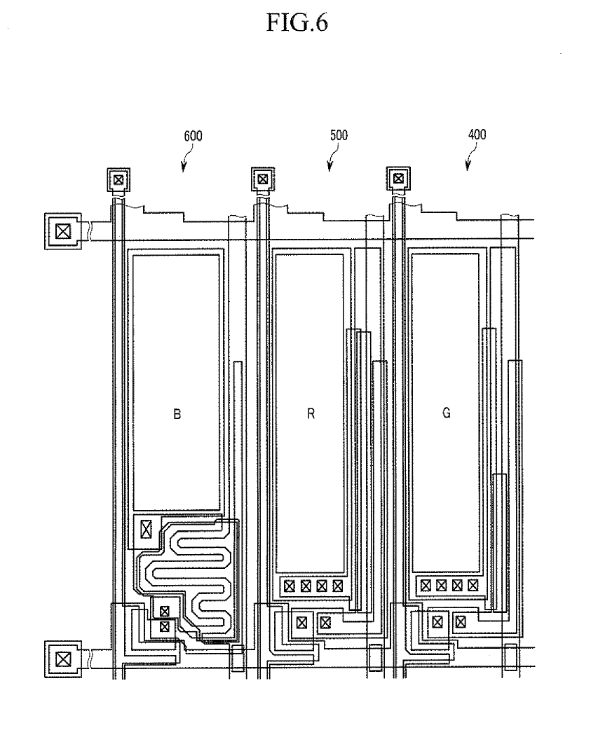

The layouts of the driving transistors Qd and the layouts of the pixel electrode 191 and the light emitting member 370 of the OLEDs shown in FIG. 2, FIG. 3 and FIG. 4 differ from one another, and in particular, as described in detail below with reference to FIG. 6, the layout of the B pixel differs from the R pixel and the G pixel.

The OLED display may emit light away from or toward the substrate 110 to display images. A combination of opaque pixel electrodes 191 and a transparent common electrode 270 may be employed with a top emission OLED display, which emits light away from the substrate 110, and a combination of transparent pixel electrodes 191 and an opaque common electrode 270 may be employed with a bottom emission OLED display, which emits light toward the substrate 110.

If the semiconductor stripes and islands 151 and 154b are made of polysilicon, they may include intrinsic regions (not shown) disposed under the control electrodes 124a and 124b and extrinsic regions (not shown) disposed opposing each other with respect to the intrinsic regions. The extrinsic regions are electrically connected to the input electrodes 173a, 173b and the output electrodes 175a, 175b. In this case, the ohmic contacts 163a, 163b, 165a, and 165bmay be omitted.

Further, the control electrodes 124a and 124b may be disposed over the semiconductor stripes and islands 151 and 154b, with the gate insulating layer 140 remaining interposed between the semiconductor stripes and islands 151 and 154b and the control electrodes 124a and 124b. The data conductors 171, 172, 173b, and 175b may be disposed on the gate insulating layer 140 and connected to the semiconductor stripes and islands 151 and 154b through contact holes (not shown) in the gate insulating layer 140. Otherwise, the data conductors 171, 172, 173b, and 175b may be disposed under, and contacting, the semiconductor stripes and islands 151 and 154b.

Referring to FIG. 2, FIG. 3, FIG. 4, and FIG. 6, an exemplary layout of an OLED according to an exemplary embodiment of the present invention is described.

FIG. 6 is a layout view of an OLED including the three pixels of FIG. 2, FIG. 3 and FIG. 4.

The B pixel 600 of FIG. 4, the R pixel 500 of FIG. 3, and the G pixel 400 of FIG. 2 are sequentially arranged as shown in FIG. 6.

As described above, the B pixel 600 has a different layout from the R pixel 500 and the G pixel 400. First, an area, a position, and a shape of the driving transistor Qd of the B pixel 600 differ from those of the R and G pixels 400 and 500. Additionally, the shape of the organic light emitting member 370 of the B pixel 600 differs from that of the R pixel 500 and the G pixel 400, while the areas of the organic light emitting members 370 of the R, G and B pixels 400, 500, and 600 are substantially the same.

In detail, the driving transistor Qd of the B pixel 600 has the longest channel width of the driving transistors Qd in the R, G and B pixels 400, 500, and 600, and the driving transistor Qd of the R pixel 500 has a longer channel width than the driving transistor Qd of the G pixel 400. Hence, the driving transistor Qd of the G pixel 400 has the shortest channel width among the R, G, and B pixels 400, 500, and 600. This relates to the emission efficiency of the OLEDs LD connected to the driving transistors Qd. In order to emit a given intensity of light, the OLED having lower emission efficiency requires more current. Thus, the driving transistor Qd connected thereto may have a longer channel width. The emission efficiency of the OLEDs is determined by the material therefor. For example, considering currently available materials, the emission efficiency decreases in the order of green, red, and blue. Hereinafter, descriptions will be given on the premise that the material for emitting blue light has the lowest emission efficiency, the material for emitting red light has an intermediate emission efficiency, and the material for emitting green light has the highest emission efficiency.

When the area occupied by the driving transistor Qd widens in order to accommodate a longer channel width, the light-emission region may decrease. However, according to an exemplary embodiment of the present invention, the channel of the driving transistor Qd may be curved or serpentine so that it may be lengthened in a small area. In this way, the driving transistor Qd may have a longer channel width without decreasing the area of the light-emission region.

As FIG. 6 shows, the channels of the driving transistors Qd of the B, R, and G pixels 400, 500, and 600 may be disposed in different regions. The channel of the driving transistors Qd of the R and G pixels 500 and 600 may be disposed between the light-emission region and the data line 171, while the channel of the driving transistor Qd of the B pixel 600 may be disposed between the light-emission region and the gate line 121. The channel widths of the driving transistors Qd of the R and G pixels 500 and 600 are short enough so that an appropriate channel width may be obtained even though the driving transistors Qd are disposed parallel to the longitudinal direction of the light-emission region. On the other hand, when the channel of the driving transistor Qd of the B pixel 600 is disposed parallel to the longitudinal direction of the light-emission region, a sufficiently long channel width, or a sufficient area for a curved or serpentine channel, may not be obtained.

The area of the light-emission regions of the B, R, and G pixels 400, 500, and 600 are substantially equal to each other even though the channels of their driving transistors Qd are disposed in different regions. This is because while the light-emission region of the B pixel 600 is shorter than that of the other pixels due to the driving transistor Qd of the B pixel 600 being disposed horizontally, the light-emission region of the B pixel 600 is wider than that of the other pixels, which include the driving transistors Qd disposed longitudinally. The interval between the B pixel 600 and the R pixel 500, or between the B pixel 600 and the G pixel 400, may be shorter than that between the R pixel 500 and the G pixel 400. As described above, the area of the light-emission regions of each pixel are substantially the same, and the channel widths of the driving transistors Qd of each pixel differ depending on the emission efficiency. Accordingly, substantially uniform light emission for red, green, and blue may be obtained.

The above description is illustrated on the premise that emission efficiency decreases from the G pixel 400 to the R pixel 500 to the B pixel 600, but emission efficiency may decrease in any order, and the present invention may be applied thereto.

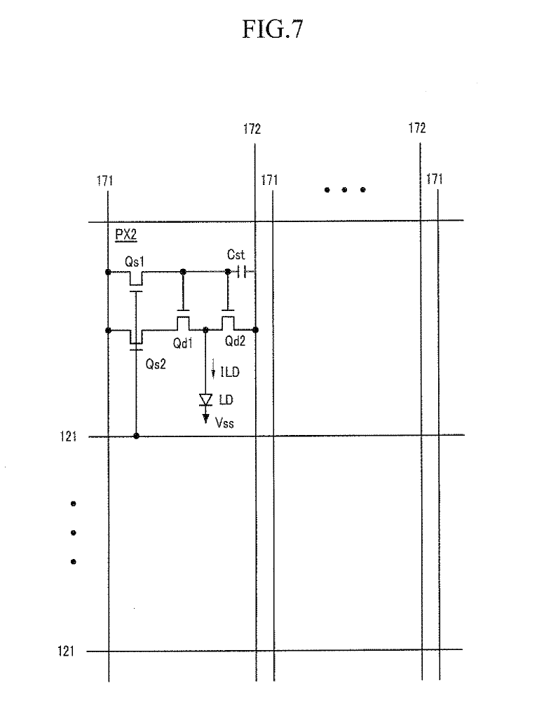

An OLED display according to another exemplary embodiment of the present invention will be described below with reference to FIG. 7, which is an equivalent circuit diagram of an OLED display.

Referring to FIG. 7, the OLED display according to another exemplary embodiment of the present includes a plurality of signal lines 121, 171, and 172, and a plurality of pixels PX2 connected thereto. The pixels PX2 are arranged substantially in a matrix.

The signal lines include a plurality of gate lines 121, a plurality of data lines 171, and a plurality of driving voltage lines 172.

Each pixel PX2 includes a first and a second driving transistor Qd1 and Qd2, a first and a second switching transistor Qs1 and Qs2, a storage capacitor Cst, and an OLED LD.

The first driving transistor Qd1 has a control terminal, an input terminal, and an output terminal. The control terminal is connected to the first switching transistor Qs1, the input terminal is connected to the second switching transistor Qs2, and the output terminal is connected to the OLED LD.

The second driving transistor Qd2 also has a control terminal, an input terminal, and an output terminal. The control terminal is connected to the first switching transistor Qs1, the input terminal is connected to the driving voltage line 172, and the output terminal is connected to the OLED LD. The second driving transistor Qd2 outputs an output current related to a voltage applied between its control terminal and output terminal.

The first and second switching transistors Qs1 and Qs2 also have control terminals, input terminals, and output terminals. Their control terminals are connected to the gate line 121, and their input terminals are connected to the data line 171. The output terminal of the first switching transistor Qs1 is connected to the control terminals of the first and second driving transistors Qd1 and Qd2, and the output terminal of the second switching transistor Qs2 is connected to the input terminal of the first driving transistor Qd1. The switching transistors Qs1 and Qs2 transmit a data signal from the data line 171 to the driving transistors Qd1 and Qd2 in response to a scanning signal supplied to the gate line 121.

The storage capacitor Cst is connected between the control terminals of the driving transistors Qd1 and Qd2 and the driving voltage line 172. The storage capacitor Cst stores the data signal supplied to the control terminals of the driving transistors Qd1 and Qd2 after the first switching transistor Qs1 turns off.

The OLED LD has an anode connected to the output terminals of the driving transistors Qd1 and Qd2, and a cathode connected to a common voltage Vss. The OLED LD emits light with an intensity that depends on an output current of the driving transistors Qd1 and Qd2, to display an image.

An operation of the pixel PX2 will be described below.

The pixel PX2 operates in a normal mode and a compensating mode. Normal display operation is performed in the normal mode, while the data voltage is adjusted to compensate for a change of threshold voltage for the driving transistors Qd1 and Qd2 in the compensating mode.

The data signal supplied to the pixel PX2 is a data voltage in the normal mode or a data current in the compensating mode. The OLED display is connected to the data line 171, and may include another driving device (not shown) for generating the data voltage and the data current.

In the normal mode, the pixel PX2 operates substantially the same as the pixel PX1 of FIG. 1. The first switching transistor Qs1 turns on in response to the scanning signal, and then the data voltage supplied to the data line 171 is applied to the control terminal of the second driving transistor Qd2 through the first switching transistor Qs1. The second driving transistor Qd2 transmits the output current (I_{LD}), based on the data voltage, to the OLED LD, and thereby the OLED LD emits light to display images.

Here, the second switching transistor Qs2 also turns on in response to the scanning signal. Hence, the data voltage is applied to the control terminal and the input terminal of the first driving transistor Qd1 through the first and second switching transistors Qs1 and Qs2, respectively. Accordingly, equal voltages are applied to the input terminal and control terminal of the first driving transistor Qd1, and even though the first driving transistor Qd1 is turned on, no current may flow through it. As described above, an image is displayed in the normal mode by flowing the data voltage through the first switching transistor Qs1 and the second driving transistor Qd2.

Generally, constant current may be supplied through the second driving transistor Qd2 for the constant luminance of the OLED LD. However, when a threshold voltage of the second driving transistor Qd2 varies, an output current transmitted through the second driving transistor Qd2 may also vary even when a constant data voltage is applied to its control terminal. Therefore, the data signal may be adjusted to compensate for the change of the threshold voltage of the second driving transistor Qd2. In the compensating mode, the data signal is adjusted.

In the compensating mode, the driving device provides a predetermined data current to the data line 171. The switching transistors Qs1 and Qs2 turn on in response to the scanning signal, and then the charge related to the predetermined data current is charged in the storage capacitor Cst through the first switching transistor Qs1. Thereby, the first driving transistor Qd1 transmits a current related to the voltage charged in the storage capacitor Cst. Here, the higher the charged voltage in the storage capacitor Cst becomes, the larger the current transmitted through the first driving transistor Qd1 becomes. The voltage is charged in the storage capacitor Cst until the first driving transistor Qd1 transmits substantially the same current as the predetermined data current supplied to the input terminal thereof through the second switching transistor Qs2. Here, the charged voltage, which is referred to as a “compensated voltage” hereinafter, corresponds to the predetermined data current on a one-to-one basis and compensates the variation of the threshold voltage of the first driving transistor Qd1.

The control terminals of the driving transistors Qd1 and Qd2 are connected to each other, so that the control terminal voltages are equal to each other. Also, the output terminals of the driving transistors Qd1 and Qd2 are connected to each other, so that the output terminal voltages are equal. The variation of the threshold voltage depends on the difference between the control terminal voltage and the output terminal voltage of each driving transistor Qd1 and Qd2 regardless of a transistor aspect ratio W/L thereof. Therefore, the variation of the threshold voltage in the driving transistors Qd1 and Qd2 is equal to each other. Accordingly, the compensated voltage for the first driving transistor Qd1 may be applied to the second driving transistor Qd2.

In the compensating mode, the compensated voltage for the predetermined data current may be read and stored in a lookup table (not shown). Then, the data voltage is compensated with reference to the compensated voltage stored in the lookup table, and then the compensated data voltage is supplied to the second driving transistor Qd2 in the normal mode. Thereby, the second driving transistor Qd2 outputs a substantially constant output current even though the threshold voltage of the second driving transistor Qd2 is varied. Hence, the luminance of the OLED LD may be substantially uniformly maintained.

If the threshold voltage changes over a long period of time, the compensation mode for each pixel PX2 may be performed in a long interval of time. Therefore, operation in the compensating mode may not affect a display operation of images even though the compensating mode is performed while displaying images in the normal mode.

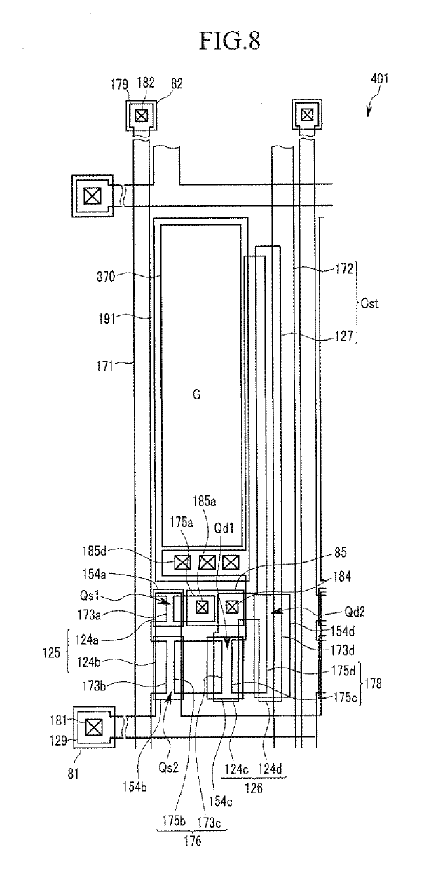

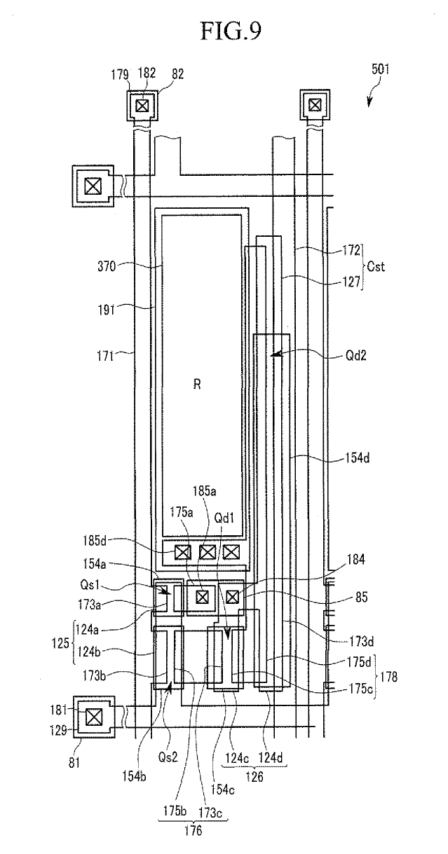

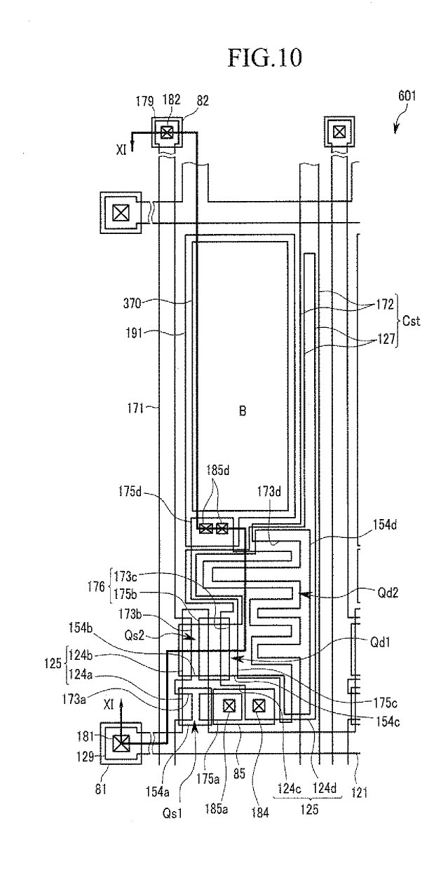

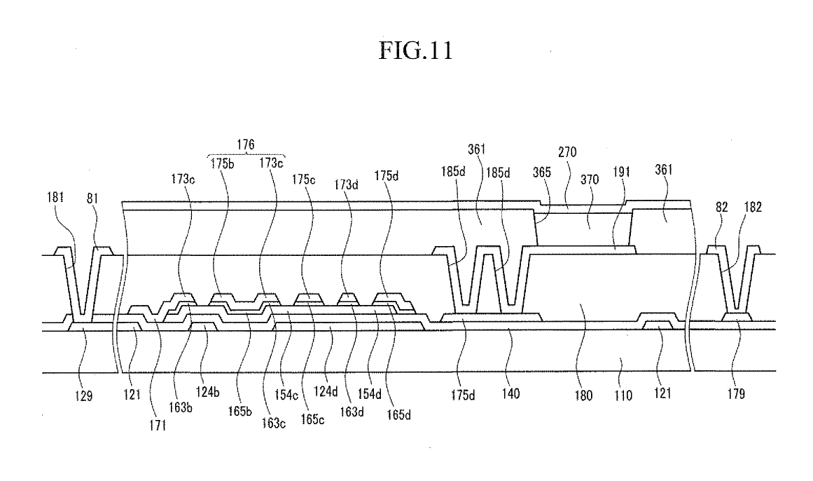

A detailed structure of the OLED display of FIG. 7 is described below with reference to FIG. 8, FIG. 9, FIG. 10, and FIG. 11. A detailed description of elements that are the same as those described in the previous embodiment is omitted.

FIG. 8, FIG. 9, and FIG. 10 are layout views respectively show three pixels of an OLED according to another exemplary embodiment of the present invention, and FIG. 11 is a sectional view taken along line XI-XI of FIG. 10.

A plurality of gate conductors, which include gate lines 121, including first control electrodes 125, and second control electrodes 126, are formed on an insulating substrate 110.

The gate lines 121 extend substantially in a transverse direction, and each gate line 121 includes an end portion 129, which has a large area to connect to another layer or an external driving circuit. The first control electrodes 125 project upward from the gate line 121.

The second control electrode 126 is spaced apart from the gate line 121.

A gate insulating layer 140 is formed on the gate conductors 121, 125, and 126.

A plurality of semiconductor islands 154a, 154b, 154c, and 154d are formed on the gate insulating layer 140. The first semiconductor island 154a and the second semiconductor island 154b are disposed on the first control electrode 125, and the third semiconductor island 154c and the fourth semiconductor island 154d are disposed on the second control electrode 126. Alternatively, at least two or more of the first to fourth semiconductor islands 154a, 154b, 154c, and 154d may be formed together as one semiconductor island. For example, the second, third, and fourth semiconductor islands 154b, 154c, and 154d may make up one semiconductor island, as shown in FIG. 10.

A plurality of pairs of first ohmic contacts 163a and 165a, a plurality of pairs of second ohmic contacts 163b and 165b, a plurality of pairs of third ohmic contacts 163c and 165c, and a plurality of pairs of fourth ohmic contacts 163d and 165d are formed on the semiconductor islands 154a, 154b, 154c, and 154d, respectively. The first, second, third, and fourth ohmic contacts 163a and 165a, 163b and 165b, 163c and 165c, and 163d and 165d are island shaped and are located in pairs on the first, second, third and fourth semiconductor islands 154a, 154b, 154c, and 154d, respectively.

A plurality of data conductors, which include data lines 171, first output electrodes 175a, first electrode members 176, second electrode members 178, and driving voltage lines 172, are formed on gate insulating layer 140 and the ohmic contacts 163a, 165a, 163b, 165b, 163c, 165c, 163d, and 165d.

The data lines 171 extend substantially in the longitudinal direction and cross with the gate lines 121. Each data line 171 includes a plurality of first and second input electrodes 173a and 173b, which extend toward the first control electrodes 125, and an end portion 179, which has a large area. The first input electrode 173a partly overlaps the first semiconductor island 154a, and the second input electrode 173b partly overlaps the second semiconductor island 154b.

The first output electrode 175a is spaced apart from the data line 171, and the first output electrode 175a and the first input electrode 173a are disposed opposing each other with respect to the first semiconductor 154a.

The first electrode member 176 is spaced apart from the data line 171. A part of the electrode member 176 forms the second output electrode 175b, which is disposed opposing the second input electrode 173b with respect to the second semiconductor island 154b, and another part of the electrode member 176 forms the third input electrode 173c, which overlaps the third semiconductor island 154c.

The second electrode member 178 is spaced apart from the data line 171. A part of the second electrode member 178 forms the third output electrode 175c, which is disposed opposing the third input electrode 173c with respect to the third semiconductor island 154c, and another part thereof forms the fourth output electrode 175d, which overlaps the fourth semiconductor island 154d.

The driving voltage lines 172 extend substantially in the longitudinal direction and cross with the gate lines 121. Each driving voltage line 172 includes the fourth input electrode 173d, which is disposed opposing the fourth output electrode 175d with respect to the fourth semiconductor island 154d.

A passivation layer 180 is formed on the data conductors and the exposed portions of the semiconductors 154a, 154b, 154c, and 154d. The passivation layer 180 has a plurality of contact holes 182, 185a, and 185d, which expose the end portions 179 of the data lines 171, the first output electrodes 175a, and the second electrode member 178, respectively. The passivation layer 180 and the gate insulating layer 140 have a plurality of contact holes 181 and 184, which expose the end portions 129 of the gate lines 121 and the fourth control electrodes 124d, respectively.

A plurality of pixel electrodes 191, a plurality of connecting members 85, and a plurality of contact assistants 81 and 82 are formed on the passivation layer 180.

The pixel electrodes 191 are connected to the fourth output electrodes 175dthrough the contact holes 185d.

The connecting members 85 are connected to the fourth control electrodes 124dand the first output electrodes 175a through the contact holes 184 and 185a, respectively, and each connecting member 85 may include a storage electrode 127 extending along a driving voltage line 172 to overlap it.

The contact assistants 81 and 82 are connected to the end portions 129 of the gate lines 121 and the end portions 179 of the data lines 171 through the contact holes 181 and 182, respectively.

A partition 361, which defines openings 365, is formed on the passivation layer 180, and a plurality of light emitting members 370 are formed in the openings 365.

A common electrode 270 is formed on the substrate including on the light emitting members 370.

In the OLED display according to present exemplary embodiment, the first control electrode 124a connected to the gate line 121, the first input electrode 173a connected to the data line 171, and the first output electrode 175a, along with the first island semiconductor 154a, form a first switching TFT Qs1, and the second control electrode 124b connected to the gate line 121, the second input electrode 173b connected to the data line 171, and the second output electrode 175b, along with the second semiconductor island 154b, form a second switching TFT Qs2.

The channel of the first switching thin film transistor Qs1 is formed in the portion of the first semiconductor island 154a disposed between the first input electrode 173a and the first output electrode 175a, and the channel of the second switching thin film transistor Qs2 is formed in the portion of the second semiconductor island 154b disposed between the second input electrode 173b and the second output electrode 175b.

Likewise, the third control electrode 124c, the third input electrode 173c, and the third output electrode 175c, along with the third semiconductor island 154c, form a first driving TFT Qd1, and the fourth control electrode 124d, the fourth input electrode 173d connected the driving voltage line 172, and the fourth output electrode 175d, along with the fourth semiconductor island 154d, form a second driving TFT Qd2.

Here, the channel of the first driving TFT Qd1 is formed in the portion of the third semiconductor island 154c disposed between the third input electrode 173c and the third output electrode 175c, and the channel of the second driving TFT Qd2 is formed in the portion of the fourth semiconductor island 154d between the fourth input electrode 173d and the fourth output electrode 175d.

Many features of the OLED display shown in FIGS. 2 to 5 are also applicable to that shown in FIGS. 8 to 11.

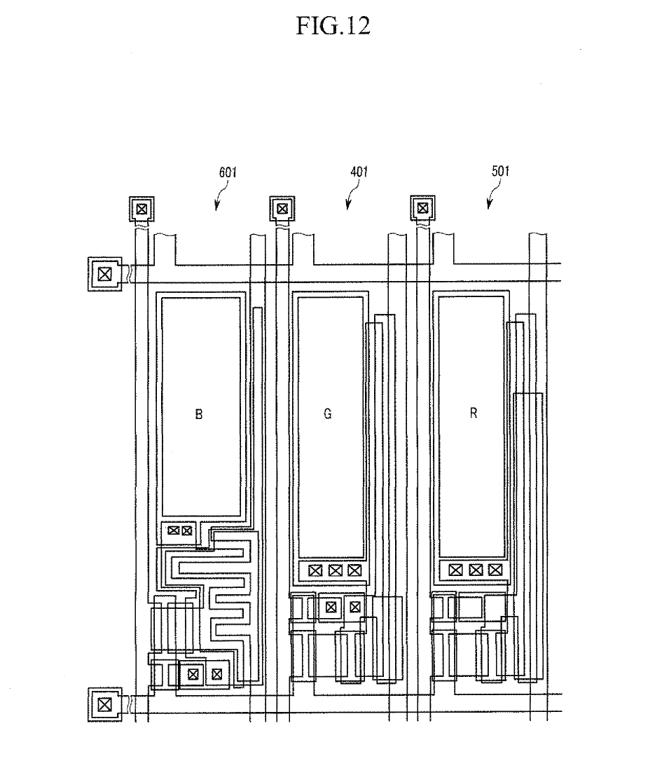

FIG. 12 is a layout view showing the three pixels of FIG. 8, FIG. 9, and FIG. 10. Referring to FIG. 12, the B pixel 601 has a different pixel structure than that of the R and G pixels 501 and 401, similar to the previous embodiment of FIG. 6. As described in the previous embodiment of FIG. 6, the area and position of the driving transistor of one pixel having the lowest emission efficiency of the three pixels differs from those of the other two pixels, and a detailed description of the pixel structure that is the same as that described in the previous embodiment is omitted.

Many features of the pixel arrangement shown in FIG. 6 are also applicable to that shown in FIG. 12.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. An organic light emitting diode (OLED) display, comprising:
a first pixel, a second pixel, and a third pixel, each pixel being defined by a gate line and a data line and comprising a light-emitting element and a driving transistor connected to the light-emitting element,
wherein the light-emitting element of the first pixel has lower light emission efficiency than that of the light-emitting element of the second pixel and the light-emitting element of the first pixel has lower light emission efficiency than that of the light-emitting element of the third pixel,
an area of the light-emitting element of the first pixel, an area of the light-emitting element of the second pixel, and an area of the light-emitting element of the third pixel are substantially the same, and
an area occupied by the driving transistor of the first pixel is larger than an area occupied by the driving transistor of the second pixel and the area occupied by the driving transistor of the first pixel is larger than an area occupied by the driving transistor of the third pixel.

2. The OLED display of claim 1, wherein a channel of the driving transistor of the first pixel is disposed in a correspondingly different position from that of a channel of the driving transistor of the second pixel and a channel of the driving transistor of the third pixel.

3. The OLED display of claim 2, wherein the channel of the driving transistor of the first pixel is disposed between the gate line and the light-emitting element of the first pixel, the channel of the driving transistor of the second pixel is disposed between the data line and the light-emitting element of the second pixel, and the channel of the driving transistor of the third pixel is disposed between the data line and the light-emitting element of the third pixel.

4. The OLED display of claim 1, wherein a channel of the driving transistor of the first pixel has a serpentine shape.

5. The OLED display of claim 1, wherein a channel width of the driving transistor of the first pixel is wider than a channel width of the driving transistor of the second pixel and the channel width of the driving transistor of the first pixel is wider than a channel width of the driving transistor of the third pixel.

6. The OLED display of claim 1, wherein the first pixel, the second pixel, and the third pixel have substantially the same width as each other.

7. The OLED display of claim 1, wherein the first pixel is a blue pixel.

8. The OLED display of claim 1, wherein the driving transistors comprise a semiconductor comprising amorphous silicon.

9. The OLED display of claim 1, wherein the first pixel, the second pixel, and the third pixel each further comprise a switching transistor connected to the gate line and the data line.

10. The OLED display of claim 1, further comprising:
a pixel electrode connected to the driving transistor; and
a common electrode facing the pixel electrode,
wherein the light-emitting element in each pixel is disposed between the pixel electrode and the common electrode of each pixel, the light-emitting element in the first pixel defining a first light-emission region, the light-emitting element in the second pixel defining a second light-emission region, and the light-emitting element in the third pixel defining a third light-emission region.

11. The OLED display of claim 10, wherein a width and a length of the first light-emission region differ from those of the second light-emission region and the third light-emission region.

12. The OLED display of claim 11, wherein the first light-emission region is wider than the second light-emission region and the third light-emission region, and the first light-emission region is shorter than the second light-emission region and the third light-emission region.

13. The OLED display of claim 10, wherein an interval between the first light-emission region and the second light-emission region or the third light-emission region adjacent to the first light-emission region is shorter than an interval between the second light-emission region and the third light-emission region.

14. The OLED display of claim 10, wherein the light-emitting element of the first pixel emits blue light.

15. An organic light emitting diode (OLED) display, comprising:
a first pixel, a second pixel, and a third pixel, each pixel including a light-emitting element and a driving transistor connected to the light-emitting element, the first pixel having a first light-emission region, the second pixel having a second light-emission region, the third pixel having a third light-emission region,
wherein the light-emitting element of the first pixel has lower light emission efficiency than that of the light-emitting element of the second pixel and the light-emitting element of the first pixel has lower light emission efficiency than that of the light-emitting element of third pixel,
a width and a length of the first light-emission region differ from those of the second light-emission region and the width and the length of the first light-emission region differ from those of the third light-emission region, and
an area of the first light-emission region, an area of the second light-emission region, and an area of the third light-emission region are substantially the same.

16. The OLED display of claim 15, wherein the first light-emission region is wider than the second light-emission region and the third light-emission region, and the first light-emission region is shorter than the second light-emission region and third light-emission region.

17. The OLED display of claim 15, wherein a channel of the driving transistor of the first pixel is disposed between a gate line and the light-emitting element of the first pixel, a channel of the driving transistor of the second pixel is disposed between a data line and the light-emitting element of the second pixel, and a channel of the driving transistor of the third pixel is disposed between a data line and the light-emitting element of the third pixel.

18. The OLED display of claim 15, wherein the light-emitting element of the first pixel emits blue light.
